(19) United States
(12) Patent Application Publication
(10) Pub. No.: US 2002/0162864 A1
(43) Pub. Date: Nov. 7, 2002

(54) Side Saddle

(76) Inventor: Daniel George Grunwald, Ventura, IA (US)

Correspondence Address: Daniel G. Grunwald, 1001 E. LAKE St., Ventua, IA, 50482, US

(21) Appl. No.: 09/853,074

(22) Filed: May 7, 2001

(51) Int. Cl. A61G 1/00; A45C 1/04; A45F 3/00

(52) U.S. Cl. 224/159; 224/671; 224/683

(57) ABSTRACT

A hard plastic curved top bracket, worn on a wide nylon belt around a person's waist for the purpose of supporting a small load, such as a child or bag of groceries. This bracket would be made of 100% polyethylene plastic by injecting this molden plastic into a metal mold.

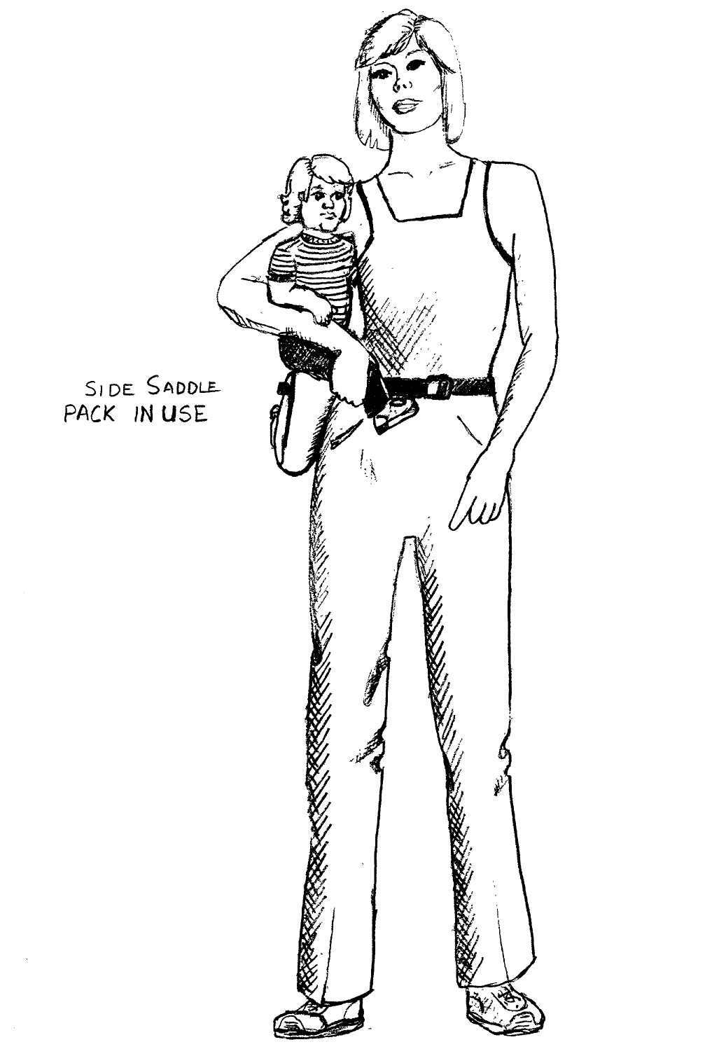

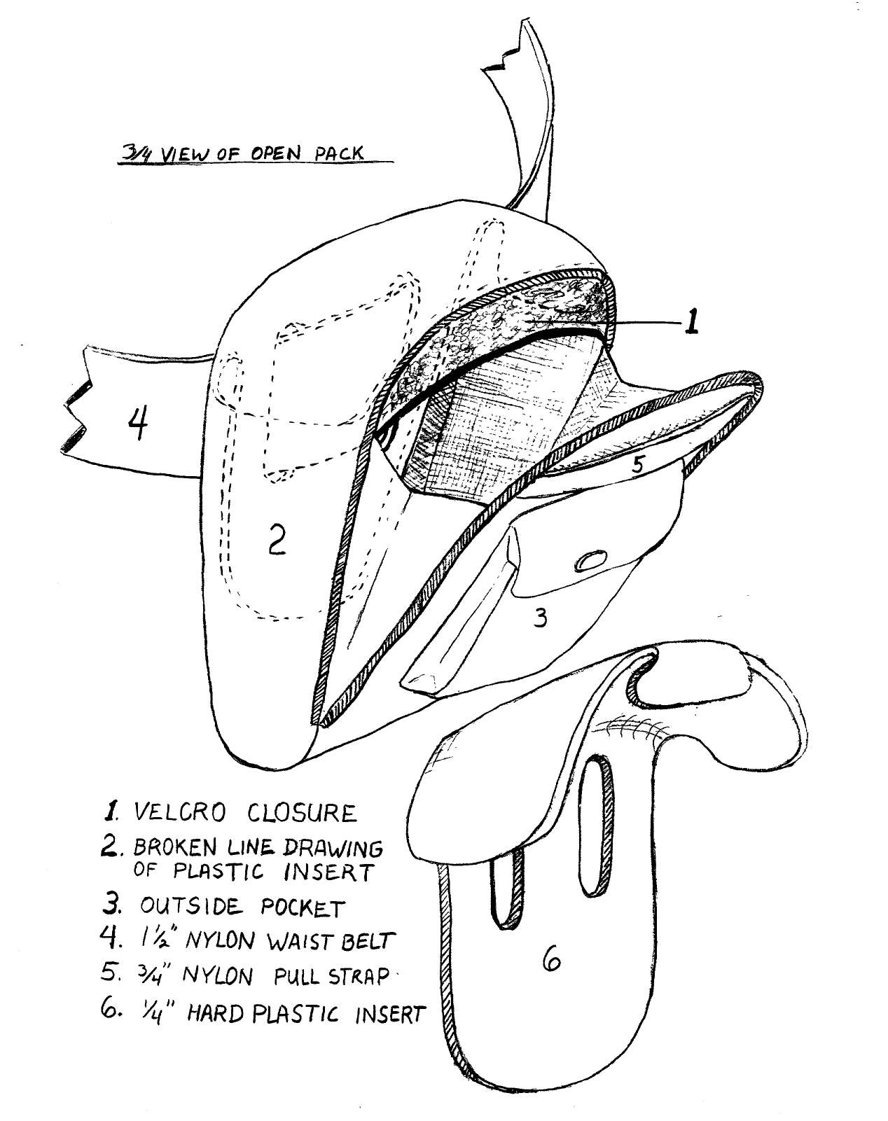

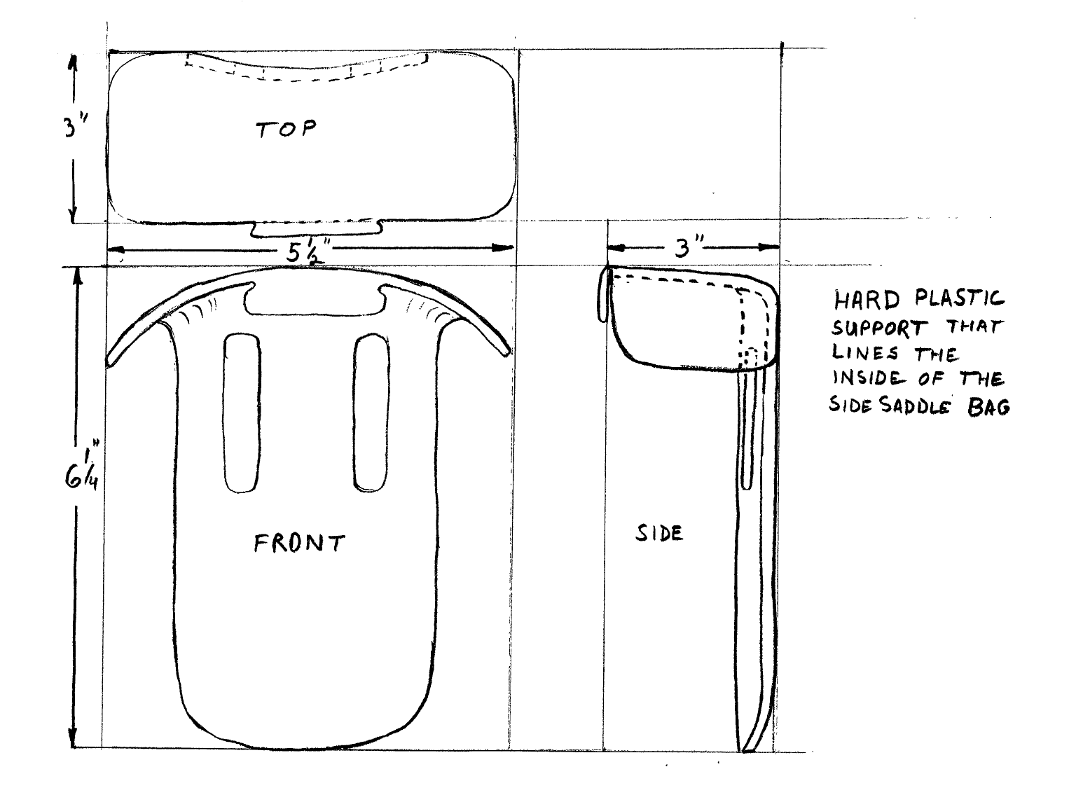

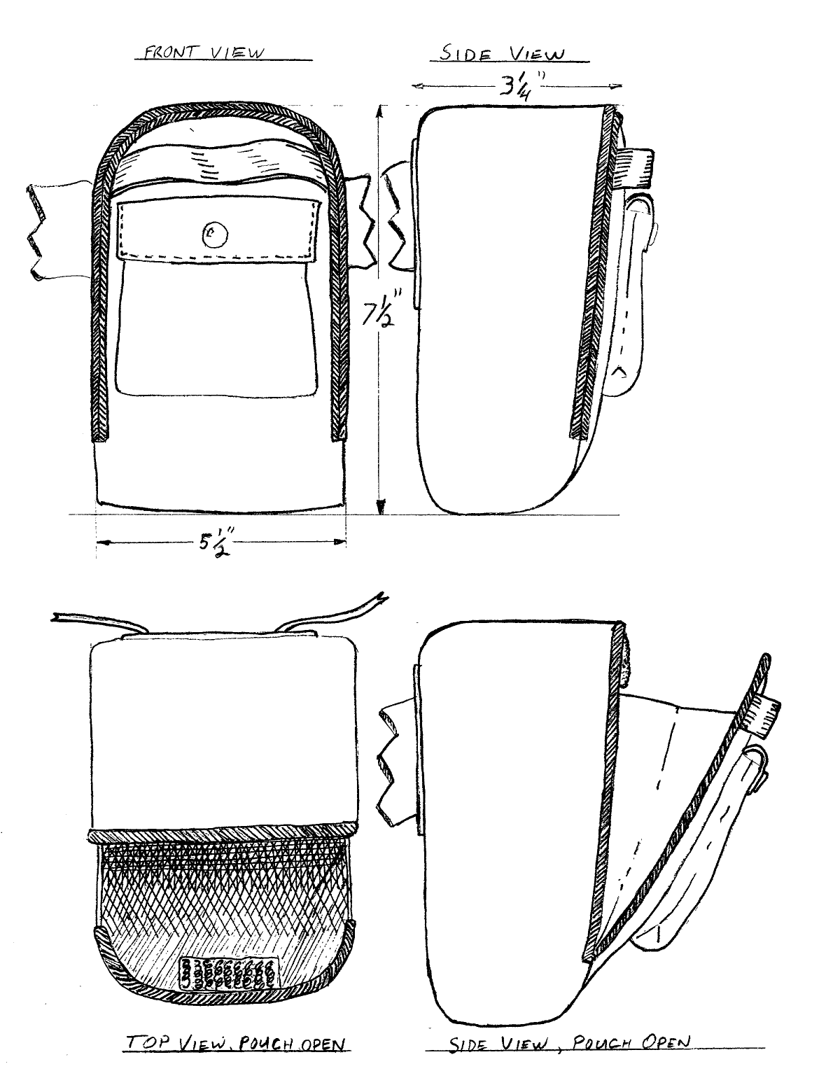

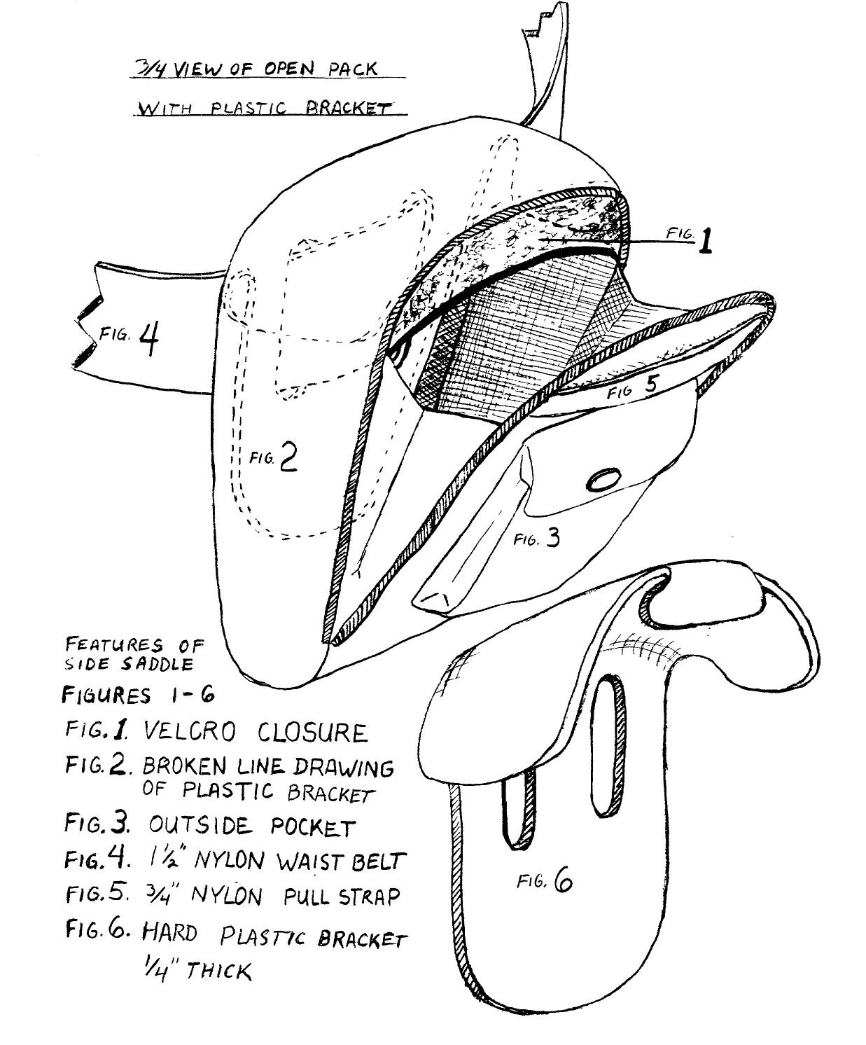

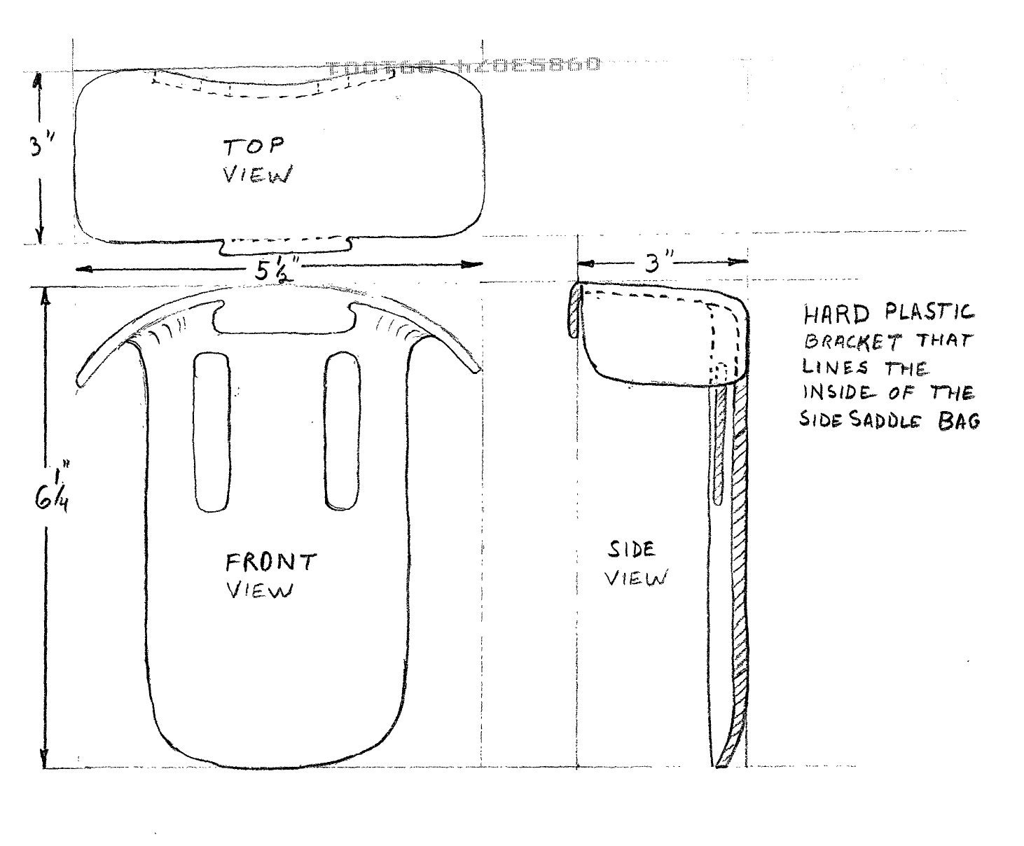

This invention is called the “Side Saddle”. It is a curved topped, hard plastic support made by a thermal plastic injection mold, which is fastened to a waist belt covered with a padded nylon pouch and worn on the hip.

It gives an extension to the user's hip which would enable that person to more easily carry a load such as a small child, or grocery bag by resting that load on top of the support and transferring the major portion of the weight to the legs, instead of the back, arms and shoulders.

It is my claim that this curved-topped, hard plastic support with pouch on a waist belt, worn on one's hip for the purpose of helping support the weight of a small child or other load is my original invention.

I hereby declare that the above claim and statements are true and that I am the original inventor of this invention.

I also understand that it is my duty to disclose any information known to or later discovered by me, which is relevant to the examination of this application by the patent office.

1. It is my claim that this curved-topped, hard plastic support with pouch on a waist belt, worn on one's hip for the purpose of helping support the weight of a small child or other load is my original invention.
I hereby declare that the above claim and statements are true and that I am the original inventor of this invention.
I also understand that it is my duty to disclose any information known to or later discovered by me, which is relevant to the examination of this application by the patent office.
